(19) United States
(12) Patent Application Publication
(10) Pub. No.: US 2011/0180495 A1
(43) Pub. Date: Jul. 28, 2011

(54) VORTEX-ENHANCED FILTRATION DEVICES

(75) Inventor: Don Schoendorfer, Santa Ana, CA (US)

(73) Assignee: KKJ, Inc., Valley Center, CA (US)

(21) Appl. No.: 13/011,670

(22) Filed: Jan. 21, 2011

Related U.S. Application Data
(60) Provisional application No. 61/297,250, filed on Jan. 21, 2010.

(51) Int. Cl. B01D 35/22; B01D 29/23

(52) U.S. Cl. 210/791; 210/415

(57) ABSTRACT

Embodiments of the present invention relate to a device for filtration comprising at least one rotor configured to create Taylor vortices on at least one side of a filtration membrane, thereby providing substantially enhanced mass transfer across the membrane.

### CROSS-REFERENCE TO RELATED APPLICATIONS

This application claims priority to U.S. Provisional Application No. 61/297,250, filed on Jan. 21, 2010. This application is also related to U.S. Pat. No. 7,425,265 (Schoendorfer), U.S. Pat. No. 7,220,354 (McLaughlin and Schoendorfer), U.S. Pat. No. 7,374,677 (McLaughlin and Schoendorfer) and U.S. Pat. No. 7,531,094, which are incorporated by reference herein in their entireties.

### BACKGROUND

1. Field

Aspects of the present invention relate to a device that creates Taylor vortices on at least one side of a filter, thereby improving mass transfer and minimizing concentration polarization. Embodiments of the present invention are particularly useful in the separation of cellular material (e.g., microorganisms such as yeast) from a fermentation broth.

2. Description of the Related Art

One of the challenges in any type of filtration process is filter clogging, scientifically described as “concentration polarization.” As a result of the selective permeability properties of the filtration membrane, the filtered material that cannot pass through the membrane becomes concentrated on the surface of the membrane. This phenomenon is clearly illustrated in the case of a “dead-end” filter, such as a coffee filter. During the course of the filtration process, the filtered material (coffee grounds) building up on the filter creates flow resistance to the filtrate, the fluid (coffee), which can pass through the filter. Consequently, filtrate flux is reduced and filtration performance diminishes.

Various solutions to the problem of concentration polarization have been suggested. These include: increasing the fluid velocity and/or pressure (see e.g., Merin et al., (1980) J. Food Proc. Pres. 4(3):183-198); creating turbulence in the feed channels (Blatt et al., Membrane Science and Technology, Plenum Press, New York, 1970, pp. 47-97); pulsing the feed flow over the filter (Kennedy et al., (1974) Chem. Eng. Sci. 29:1927-1931); designing flow paths to create tangential flow and/or Dean vortices (Chung et al., (1993) J. Memb. Sci. 81:151-162); and using rotating filtration to create Taylor vortices (see e.g., Lee and Lueptow (2001) J. Memb. Sci. 192:129-143 and U.S. Pat. Nos. 5,194,145, 4,675,106, 4,753,729, 4,816,151, 5,034,135, 4,740,331, 4,670,176, and 5,738,792, all of which are incorporated herein in their entirety by reference thereto). In U.S. Pat. No. 5,034,135, Fischel discloses creating Taylor vorticity to facilitate blood fractionation. Fischel also describes variations in the width of the gap between a rotary spinner and a cylindrical housing, but does not teach variation in this width about a circumferential cross-section.

Taylor vortices may be induced in the gap between coaxially arranged cylindrical members by rotating the inner member relative to the outer member. Taylor-Couette filtration devices generate strong vorticity as a result of centrifugal flow instability (“Taylor instability”), which serves to mix the filtered material concentrated along the filter back into the fluid to be processed. Typically, a cylindrical filter is rotated within a stationary outer housing. It has been observed that membrane fouling due to concentration polarization is very slow compared to dead-end or tangential filtration. Indeed, filtration performance may be improved by approximately one hundred fold.

The use of Taylor vortices in rotating filtration devices has been applied to separation of plasma from whole blood (See e.g., U.S. Pat. No. 5,034,135). For that application, the separator had to be inexpensive and disposable for one-time patient use. Further, these separators had to operate for only relatively short periods of time (e.g., about 45 minutes). Moreover, the separator was sized to accept the flow rate of blood that could reliably be collected from a donor (e.g., about 100 ml/minute). This technology provided a significant improvement to the blood processing industry. The advantages and improved filtration performance seen with rotating filtration systems (Taylor vortices) have not been explored in other areas of commercial filtration—including filtration of fermentation products (e.g., wine, beer, biotech fermentations).

### SUMMARY

In one embodiment, a filtration device is provided, the filtration device comprising a cylindrical housing, a filter element disposed coaxially within the housing, a cylindrical rotor disposed coaxially within the filter element, and a filter support configured to support the filter element coaxially between the rotor and the housing, wherein a gap is located between the rotor and the filter element.

In an embodiment of the filtration device, the gap is sized to create Taylor vortices during operation.

In an embodiment of the filtration device, both the rotor and the nonrotating barrier comprise filtration elements.

In an embodiment of the filtration device, the gap is sized and/or the rotor is rotated at a speed to provide a Taylor number of about 100 to about 60000 during operation.

In an embodiment of the filtration device, the gap is sized and/or the rotor is rotated at a speed to provide a Taylor number of about 200 to about 10000 during operation.

In an embodiment of the filtration device, the gap is sized and/or the rotor is rotated at a speed to provide a Taylor number of about 400 to about 4000 during operation.

In an embodiment of the filtration device, the gap is sized and/or the rotor is rotated at a speed to provide a Taylor number of about 500 to about 3000 during operation.

In an embodiment of the filtration device, the gap is sized and/or the rotor is rotated at a speed to provide a Taylor number of about 600 to about 1000 during operation.

In an embodiment of the filtration device, the gap is sized and/or the rotor is rotated at a speed to provide a shear rate of about 1270 to about 152400 sec⁻¹ during operation.

In an embodiment of the filtration device, the gap is sized and/or the rotor is rotated at a speed to provide a shear rate of about 3810 to about 76200 sec⁻¹ during operation.

In an embodiment of the filtration device, the gap is sized and/or the rotor is rotated at a speed to provide a shear rate of about 5080 to about 38100 sec⁻¹ during operation.

In an embodiment of the filtration device, the gap is sized and/or the rotor is rotated at a speed to provide a shear rate of about 6350 to about 20320 sec⁻¹ during operation.

In an embodiment of the filtration device, the gap is sized and/or the rotor is rotated at a speed to provide a shear rate of about 7620 to about 12700 sec⁻¹ during operation.

In an embodiment of the filtration device, the gap is sized and/or the rotor is rotated at a speed to provide a ratio of Taylor number to shear rate of about 0.02 to about 15 sec during operation.

In an embodiment of the filtration device, the gap is sized and/or the rotor is rotated at a speed to provide a ratio of Taylor number to shear rate of about 0.04 to about 8 sec during operation.

In an embodiment of the filtration device, the gap is sized and/or the rotor is rotated at a speed to provide a ratio of Taylor number to shear rate of about 0.08 to about 1 sec during operation.

In an embodiment of the filtration device, the gap is sized and/or the rotor is rotated at a speed to provide one or more of a Taylor number of about 100 to about 60000 or about 200 to about 10000 or about 400 to about 4000 or about 500 to about 3000 or about 600 to about 1000, a shear rate of about 1270 to about 152400 sec⁻¹ or about 3810 to about 76200 sec⁻¹ or about 5080 to about 38100 sec⁻¹ or about 6350 to about 20320 sec⁻¹ or about 7620 to about 12700 sec⁻¹ and a ratio of Taylor number to shear rate of about 0.02 to about 15 sec or about 0.04 to about 8 sec or about 0.08 to about 1 sec.

In an embodiment of the filtration device, each filtration element defines a filtration area, and the sum of the filtration areas is between about 50 and 50000 cm².

In an embodiment of the filtration device, each filtration element defines a filtration area, and the sum of the filtration areas is between about 100 and 25000 cm².

In an embodiment of the filtration device, filtration element defines a filtration area, and the sum of the filtration areas is between about 300 and 20000 cm².

In an embodiment of the filtration device, each filtration element defines a filtration area, and the sum of the filtration areas is between about 800 and 12000 cm².

In an embodiment of the filtration device, the filtration element support comprises a plurality of element support sections, wherein each section supports a substantially different portion of the filtration element.

In an embodiment of the filtration device, the filtration element support comprises a plurality of element support sections, wherein each section supports a substantially different portion of the filtration element, and each of the plurality of filtration element support sections can be separated from the filtration element.

In another embodiment, a filtration method is disclosed. The method comprises providing a filtration device as described above; rotating the rotor by engaging a rotational drive means; introducing a solution or suspension to be filtered into the feed port of the filtration device, wherein the solution or suspension comprises a clear liquid and contaminating matter; collecting a clarified filtrate, substantially free of contaminating matter, from the at least one filtrate ports; and collecting a concentrate comprising the contaminating matter from the concentrate port. The solutions or suspensions to be filtered can be selected from the group consisting of fermentation broth (wört) for beer, fermentation broth for wine, cider, fermentation broth for a distilled spirit, unseparated (whole) fermentation broth, separated fermentation broth, an extract, a plant stream and a fruit juice.

### BRIEF DESCRIPTION OF THE DRAWINGS

FIG. 1 shows a Taylor filtration device having a multipart filter support.

FIG. 2 is a sectional view of the rotational filtration device according to one embodiment of the present invention.

FIG. 3 is a cross sectional view of the rotational filtration device at line A-A′ of FIG. 2.

### DETAILED DESCRIPTION OF THE PREFERRED EMBODIMENT

Filtration under conditions which produce Taylor vortices, such as those where a Taylor number of about 100 to about 60000 is generated, can be utilized to separate components present in a variety of streams, including fermentation broths, agricultural process streams, and chemical and waste streams. Filtration under conditions which have a shear rate of about 1270 to about 152400 sec⁻¹, or under conditions which have a ratio of Taylor number to shear rate of about 0.02 to about 15 sec, or under conditions providing a combination of these conditions can also be utilized to separate components present in a variety of streams

It is well known that Taylor vortices, otherwise referred to herein as Taylor vorticity, can increase the mass transfer through a filter by one or two orders of magnitude. This is useful where it is desirable to remove a component of a fluid by size separation from a feed fluid. In other separation processes the components of the feed fluid are removed by following a concentration gradient.

As described above, concentration polarization can be a problem on the feed and filtrate sides of a membrane. In preferred embodiments of the present invention, the problems of concentration polarization on both sides of a filtration membrane can be solved by creating Taylor vortices on both sides of the membrane or by modifying the shear characteristics on both sides of the membrane, or both.

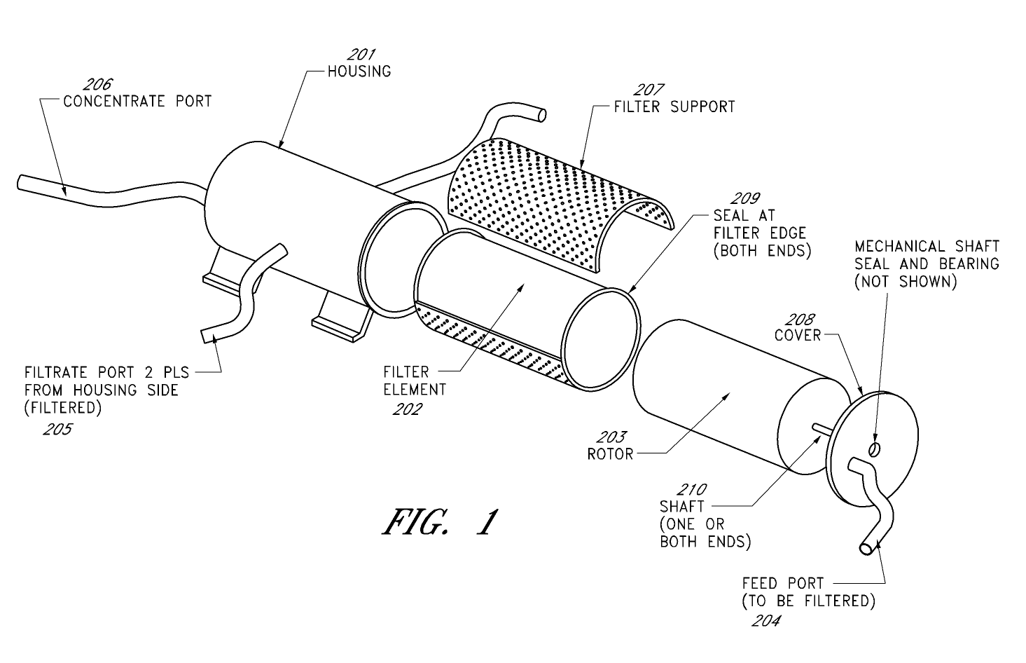

In one embodiment, a filtration device utilizing Taylor vortices can utilize a filtration surface having a multi-piece backing, such as the device shown in FIG. 1. In FIG. 1, a housing 201 includes a filter element 202 which surrounds a rotor 203. The rotor 203 can be operably positioned through the use of bearing surfaces, magnetic suspension, fluid suspension or one or more mechanical shafts 210 to provide a gap between the rotor and the filter element which allows the material being filtered to flow from the feed port 204, between the rotor 203 and the filter element 202, and exit at the concentrate port 206. A second gap can be provided between the filter housing 201 and the filter element 202 to allow flow of filtration from the filter element 202 to one or more filtrate ports 205. The filter element 202 can be sealed to the housing 201 and/or one or more covers 208 to substantially prevent feed material from bypassing the filter element 202 and entering a filtrate port 205. In some embodiments, a filter support 207 can at least partially surround the filter element 202 to increase the strength and pressure capability of the filter element. In some embodiments, a filter support 207 can have surface features, such as paths, channels, pores, holes, etc. to provide a flow path for the filtrate to reach a filtrate port 205. Surface features on the filter support 207 can be on an interior surface, and exterior surface, or both.

Suitable designs for filtrate support 207 can include those comprising 1, 2, 3, 4, or more sections or pieces. In some embodiments, individual sections or pieces can be circular, so as to slide onto the filter element 202 like a ring or sleeve. In some embodiments, individual sections can extend over only a portion of the perimeter of the filter element 202, including designs related to those shown in FIG. 1.

Sealing between filter support sections can be provided, but is not necessary, and can be achieved through close tolerance of the individual sections to one another or to another part, deformation of sections against one another or another part, gaskets, O-rings, welding, adhesives, caulk, or any other suitable means. Individual pieces or sections of filter support 207 can be held in place, such as by attachment at the ends of the filter element 202, interfacing with the housing 201 and/or the filter element 202, bands, straps, lock rings, tabs, adhesives, etc.

In some embodiments, a cover or a removable cover 208 can be located at one end or both ends of the filter housing 201. Attachment of the cover 208 to the housing 201 can be by thread, flange, clamp, or other suitable means, and can include any appropriate sealing device including gaskets, O-rings, etc. The filter element can seal to the housing 201, the cover 208, or both.

In some embodiments, a shaft 210 can extend from the rotor 203 to a cover 208 or a closed end of the housing and abut a surface of cover 208 or closed end of the housing 201. Alternatively, the shaft 210 can pass through the cover 208 or closed end. Bearings can be located on the inside or outside of the cover 208 or housing end, and seals, such as mechanical seals, labyrinth seals, lip seals, or packing glands can be provided on the housing or cover 208 to reduce leakage along the shaft 210.

In some embodiments, a second shaft can be located at the opposite end of the filter element and housing from the first shaft 210.

In some embodiments, a fluid path can be provided through the middle of the shaft to the exterior of the housing. Such a flow path through shaft 210 can be utilized in conjunction with, for example, the placement of a filter element on the rotor 203 to allow filtration to occur through the rotor with filtrate exiting through the flow path through the shaft 210. In some embodiments, a flow path through shaft 210 can be utilized as a discharge point for concentrate, with at least a portion of the concentrate material entering the rotor, such as at a point distal from the feed port, passing through the rotor, and then exiting through the flow path in shaft 210.

In various embodiments, a rotor with a filter element can be utilized in conjunction with a filter element positioned between the housing 201 and the rotor 203, thus providing more than one filtration surface within a single housing. In some embodiments, the filtration characteristics of the multiple filtration surfaces can be the same. In some embodiments, the filtration characteristics of the multiple filtration surfaces can be different. Various characteristics that can be the same or different between the multiple filtration surfaces include pore size, material of construction, surface treatment, ionic characteristics, etc.

In operation, a feed stream can enter through feed port 204, and the fluid can pass between the rotor 203 and the filter element 202, and exit at concentrate port 206. A filtrate material passes through the filter element 202, and is discharged from the one or more filtrate ports 205. At the same time, the rotor can rotate so as to facilitate the formation of Taylor vortices and/or increase the sheer the fluid is exposed to.

The rotational speed of rotor 203 and the dimensions of the housing 201 and various parts within the housing, such as the rotor 203 and the filter element 202 can be varied to provide different amounts of filtration area as well as different shear rates and different Taylor flow/Taylor vortex characteristics. Any of a variety of known rotational drive means can be used to achieve the desired rotational speed of the rotor. These include e.g., a motor, an electric motor, a turbine (as discussed below), etc.

The determination of shear rate and Taylor Number are known in the art. See, e.g., Hermann Schlichting, “Boundary Layer Theory” (McGraw-Hill, 1968, updated versions available from Springer).

$$shear rate = \frac{s}{h}$$

Where s=velocity, and
h=distance between the surfaces

For a cylindrical rotor of radius R rotating at a speed of ω rpm, with a gap between the rotor and adjacent wall (filter housing or filter element, depending on configuration) d (d and R having consistent units), the equation becomes:

$$Shear rate = \frac{2 πω R}{d}$$

For similar geometry, the Taylor Number can be described as:

$$Ta = \frac{{Ud ( \frac{d}{R} )}^{0.5}}{v}$$

Where ν is the kinematic viscosity, with units of cm/sec, and

$$U = \frac{2 π R ω}{60}$$

Suitable configurations of the filter and speed of the rotor include those where the Taylor number is within a range of about 100 to about 60000 or about 200 to about 10000 or about 400 to about 4000 or about 500 to about 3000 or about 600 to about 1000. Suitable configurations and speeds include those where wavy vortex flow is present and where spiral vortex flow is present.

Suitable configurations of the filter and speed of the rotor include those where the shear rate is about 1270 to about 152400 sec⁻¹ or about 3810 to about 76200 sec⁻¹ or about 5080 to about 38100 sec⁻¹ or about 6350 to about 20320 sec⁻¹ or about 7620 to about 12700 sec⁻¹.

Suitable configurations of the filter and speed of the rotor include those where the ratio of the Taylor number to the shear rate is about 0.02 to about 15 sec or about 0.04 to about 8 sec or about 0.08 to about 1 sec.

In some embodiments, the Taylor number will be within a range of about 100 to about 60000 or about 200 to about 10000 or about 400 to about 4000 or about 500 to about 3000 or about 600 to about 1000 and the shear rate will be within a range of about 1270 to about 152400 sec⁻¹ or about 3810 to about 76200 sec⁻¹ or about 5080 to about 38100 sec⁻¹ or about 6350 to about 20320 sec⁻¹ or about 7620 to about 12700 sec⁻¹. In some embodiments, the Taylor number will be within a range of about 100 to about 60000 or about 200 to about 10000 or about 400 to about 4000 or about 500 to about 3000 or about 600 to about 1000 and the ratio of the Taylor number to the shear rate is about 0.02 to about 15 sec or about 0.04 to about 8 sec or about 0.08 to about 1 sec. In some embodiments, the shear rate is within a range of about 1270 to about 152400 sec⁻¹ or about 3810 to about 76200 sec⁻¹ or about 5080 to about 38100 sec⁻¹ or about 6350 to about 20320 sec⁻¹ or about 7620 to about 12700 sec⁻¹ and the ratio of the Taylor number to the shear rate is about 0.02 to about 15 sec or about 0.04 to about 8 sec or about 0.08 to about 1 sec. In some embodiments, the flow through the filter will exhibit where wavy vortex flow is present and where spiral vortex flow characteristics and the shear rate is about 1270 to about 152400 sec⁻¹ or about 3810 to about 76200 sec⁻¹ or about 5080 to about 38100 sec⁻¹ or about 6350 to about 20320 sec⁻¹ or about 7620 to about 12700 sec⁻¹ or the ratio of the Taylor number to shear rate is about 0.02 to about 15 sec or about 0.04 to about 8 sec or about 0.08 to about 1 sec.

Suitable sizes of filters include those having relatively small membrane areas, such as about 10, 20, 40, or 60 cm² of filtration area. Suitable filters also include those having about 3000, 6000, 9000, 10000, 11000 cm² of surface area or more, including filters having areas of about 1 m², about 2 m², about 4 m², about 10 m² or more. As the amount of surface area increases, the diameter of the filter element, the length of the filter element, can be increased with adjustments in the gap between the rotor and filter element or the gap between rotating filter element and housing or, where two filtration elements are present, the gap between the rotating filter element and the stationary filter element can be adjusted and the speed of the rotating part adjusted to provide an acceptable value of the Taylor number, the shear rate, the ratio of Taylor number to shear rate, or some acceptable combination of these values. In some embodiments, two or more filtration devices can be arranged in parallel, in series, or a combination of parallel and series.

Suitable configurations include those described in Table 1.

TABLE 1
Calculation of Taylor number, shear rate and ratio of Taylor number to shear rate for various configurations and rotation speeds

| | Case | | Mem- | | | | | | | | | | |
|---|---|---|---|---|---|---|---|---|---|---|---|---|---|
| Case | Circum- | Case | brane | | Case | Case | | | | | | shear | |
| ID | ference | Length | area | | dia | length | Gap | Gap | | U | Taylor | rate | Tay/Shear |
| (cm) | (cm) | (cm) | (cm\hat{ }2) | % of m\hat{ }2 | (in) | (in) | (in) | (cm) | RPM | (cm/sec) | number | (1/sec) | (sec) |
| 2.54 | 7.9756 | 7.62 | 60.8 | 0.6 | 1 | 3 | 0.024 | 0.06096 | 3600 | 479 | 639 | 7850 | 0.081 |
| 10 | 31.4 | 100 | 3140 | 31.4 | 3.9 | 39.4 | | | | | | | |
| 10 | 31.4 | 50 | 1570 | 15.7 | 3.9 | 19.7 | | | | | | | |
| 10 | 31.4 | 100 | 3140 | 31.4 | 3.9 | 39.4 | | | | | | | |
| 10 | 31.4 | 100 | 3140 | 31.4 | 3.9 | 39.4 | | | | | | | |
| 10 | 31.4 | 100 | 3140 | 31.4 | 3.9 | 39.4 | | | | | | | |
| 20 | 62.8 | 100 | 6280 | 62.8 | 7.9 | 39.4 | | | | | | | |
| 30 | 94.2 | 100 | 9420 | 94.2 | 11.8 | 39.4 | | | | | | | |
| 40 | 125.6 | 100 | 12560 | 125.6 | 15.7 | 39.4 | | | | | | | |
| 40 | 125.6 | 80 | 10048 | 100.48 | 15.7 | 31.5 | | | | | | | |
| 44 | 138.16 | 80 | 11052.8 | 110.528 | 17.3 | 31.5 | | | | | | | |
| 42 | 131.88 | 80 | 10550.4 | 105.504 | 16.5 | 31.5 | 0.024 | 0.06096 | 3600 | 7913 | 2599 | 129803 | 0.020 |
| 42 | 131.88 | 80 | 10550.4 | 105.504 | 16.5 | 31.5 | 0.05 | 0.127 | 3600 | 7913 | 7815 | 62306 | 0.125 |
| 42 | 131.88 | 80 | 10550.4 | 105.504 | 16.5 | 31.5 | 0.1 | 0.254 | 600 | 1319 | 3684 | 5192 | 0.710 |
| 42 | 131.88 | 80 | 10550.4 | 105.504 | 16.5 | 31.5 | 0.065 | 0.1651 | 600 | 1319 | 1931 | 7988 | 0.242 |
| 42 | 131.88 | 80 | 10550.4 | 105.504 | 16.5 | 31.5 | 0.2 | 0.508 | 2000 | 4396 | 34733 | 8654 | 4.014 |
| 42 | 131.88 | 80 | 10550.4 | 105.504 | 16.5 | 31.5 | 0.2 | 0.508 | 1800 | 3956 | 31260 | 7788 | 4.014 |
| 42 | 131.88 | 80 | 10550.4 | 105.504 | 16.5 | 31.5 | 0.2 | 0.508 | 1725 | 3792 | 29957 | 7464 | 4.014 |
| 42 | 131.88 | 80 | 10550.4 | 105.504 | 16.5 | 31.5 | | 0.106 | 1800 | 3956 | 2980 | 37325 | 0.080 |
| 42 | 131.88 | 80 | 10550.4 | 105.504 | 16.5 | 31.5 | | 0.106 | 1700 | 3737 | 2814 | 35251 | 0.080 |
| 42 | 131.88 | 80 | 10550.4 | 105.504 | 16.5 | 31.5 | | 0.106 | 1000 | 2198 | 1655 | 20736 | 0.080 |
| 42 | 131.88 | 80 | 10550.4 | 105.504 | 16.5 | 31.5 | | 0.106 | 500 | 1099 | 828 | 10368 | 0.080 |
| 42 | 131.88 | 80 | 10550.4 | 105.504 | 16.5 | 31.5 | | 0.106 | 400 | 879 | 662 | 8294 | 0.080 |
| 42 | 131.88 | 80 | 10550.4 | 105.504 | 16.5 | 31.5 | | 0.106 | 385 | 846 | 637 | 7983 | 0.080 |

assume kinematic viscosity (v) = 1 mm\hat{ }2/sec = 0.01 cm\hat{ }/sec
U = 3.14*(D*RPM/60)
Taylor number = U/v*gap*(gap/R)\hat{ }0.5
shear rate = 3.14*(D*RPM/60)/gap

In various embodiments, a filtration element can comprise a membrane filtration surface, such as those utilized in reverse osmosis, ultrafiltration, nanofiltration or microfiltration. Filtration elements can utilize asymmetric pore configurations, where the surface closest to the feed has a smaller opening than the surface furthest from the feed. Filtration elements can be constructed of any suitable material, including polymers, ceramics, and metals, and can include materials made by sintering or casting or film technology. In some embodiments, a filtration element and support can be capable of sustaining pressure differences of about 10 to about 1000 psi or more, or between about 10 and 600 psi or between about 20 and 400 psi or between about 30 and 150 psi or between 50 and 100 psi. In some embodiments, the filtration element would rupture, tear or leak if utilized without the support.

In some embodiments, a filtration device described herein can be utilized to perform a separation on a fermentation broth, a preprocessed fermentation broth, a plant or animal stream or a preprocessed plant or animal stream. Suitable fermentation broths include those utilized in the beverage industry, such as for beer, wine, cider or distilled spirits; as well as those used in the fuel industry, such as for ethanol or other alcohols, triglycerides, partial glycerides, hydrocarbons, phospholipids, partial phospholipids, biodiesel, etc.; pharmaceutical industry, such as for drug and biologic production; food industry such as for xanthan gum, gellan gum, nutritional oils, including those derived from fungi or microalgae; yeast and protein broths; and includes whole fermentation broths, separated fermentation broths, extracts, reacted broths, side streams, waste streams, etc. Suitable plant or animal streams include juices (e.g. orange, apple, pear, pomegranate, pineapple, etc.), protein production streams (soy, beef, chicken, broth), oil or lipid production streams, carbohydrate production streams, etc. and includes whole extracts and hydrolysates, separated extracts and hydrolysates, reacted extracts and hydrolysates, side streams, waste streams, etc.

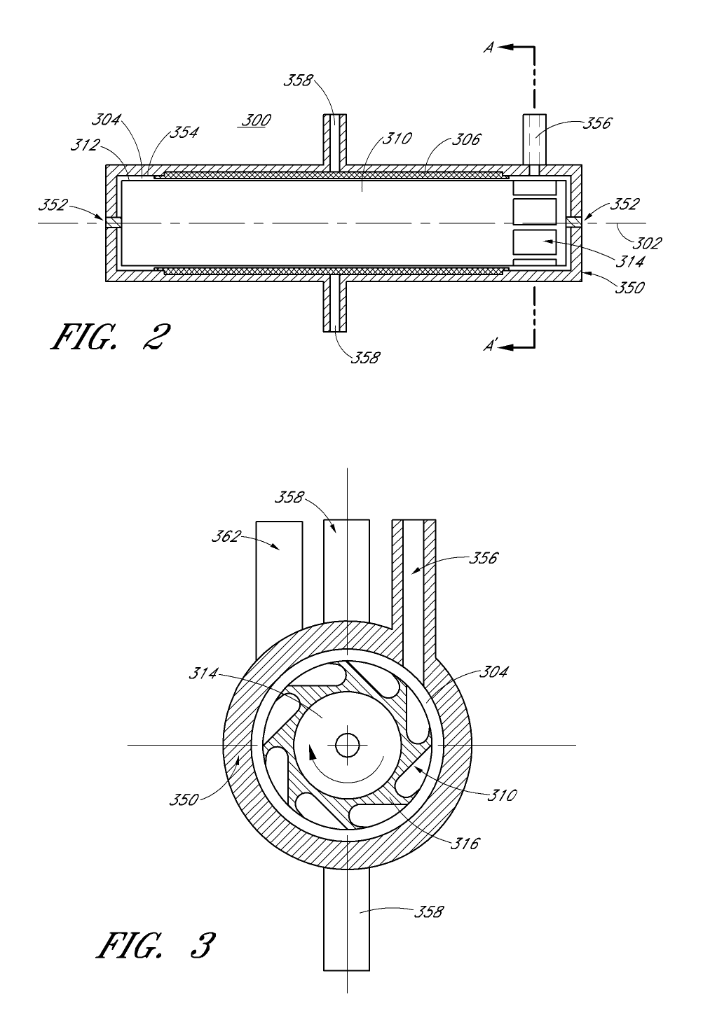

In some embodiments, a turbine or other rotation-inducing device can be incorporated into the design of the filter to utilize fluid movement to rotate the rotor. In FIG. 2 is a sectional view of the rotational filtration device 300 according to one embodiment of the present invention. The sectional view shows the housing 350 of the rotational filtration device bisected along line A-A′, but the rotor 310 is shown intact. The rotational filtration device 300 comprises a rotor 310 arranged coaxially within the bore of a housing 350. In the illustrated embodiment both the rotor 310 and the bore are cylindrical. In one embodiment the rotor 310 is mounted on two posts 352 within the housing 350 along the central axis 302 of the rotational filtration device 300. These posts limit both the axial and the radial motion of the rotor 310. There is a gap 304 between the outer wall 312 of the rotor 310 and the inner wall 354 of the housing 350. The gap 304 extends evenly around the rotor 310. In another embodiment the posts 352 are not used and the rotor 310 is suspended within the housing 350 solely by the flow of process fluid through the gap 304.

The housing 350 comprises an inlet port 356 and one or more filtrate ports 358. The process fluid flows into the rotational filtration device 300 via the inlet port 356. The filtrate (filtered process fluid) flows out of the rotational filtration device 300 via the filtrate ports 358. Additionally, the housing 350 may comprise an outlet port (not shown), through which the process fluid flows out of the rotational filtration device 300. The outlet port allows the flow of process fluid through the rotational filtration device 300 at a greater rate than the flow of filtrate out of the rotational filtration device 300. The number of each port may be adjusted to modify the flow of the process fluid.

The rotor 310 comprises a rotational drive means 314 which is positioned at least partially within the flow path of the process fluid to drive the rotation of the rotor 310. In the illustrated embodiment, the rotational drive means 314 comprises a plurality of turbine vanes. These turbine vanes are positioned at the inlet port 356 and the flow of process fluid into the rotational filtration device 300 via the inlet port 356 drives the rotation of the rotor 310. Other locations for the rotational drive means 314 include near the outlet port, on a shaft extending from either end of the rotor, an intermediate position along the rotor between the inlet port and the outlet port, or some combination of these locations.

A filter 306 is disposed within the gap 304. In the illustrated embodiment, the filter 306 is mounted on the inner wall 354 of the housing 350. In another embodiment, the filter 304 may be mounted on the outer wall 312 of the rotor 310. For this embodiment, the inlet port 356 is relocated to direct the flow of the process fluid into the interior of the rotor 310 to accommodate the mounting of the filter 306 on the outer wall 312 of the rotor 310.

According to some embodiments, the filter comprises of a filtration membrane which is selected from the group including micro, macro, nano, dialysis and reverse osmosis membranes.

FIG. 3 is a cross sectional view of the rotational filtration device 300 at line A-A′ of FIG. 2. As discussed above with reference to FIG. 2, the rotor 310 comprises a rotational drive means 314 which is positioned at least partially within the flow path of the process fluid to drive the rotation of the rotor 310. The rotational drive means 314 comprises a plurality of turbine vanes 316. These turbine vanes 316 are positioned at the inlet port 356 and sculpted to capture the flow of process fluid into the rotational filtration device 300 via the inlet port 356, which drives the rotation of the rotor 310. Preferably, the process fluid is pumped at a sufficiently high flow rate and pressure to generate the desired rotational speed of the rotor.

Those skilled in the art will appreciate that numerous changes and modifications may be made to the preferred embodiments of the invention and that such changes and modifications may be made without departing from the spirit of the invention disclosed herein. It is therefore intended that the appended claims cover all such equivalent variations as may fall within the true spirit and scope of the invention.

### EXAMPLE

### Filtration of a Fermentation Broth

The fermentation broth from wine production that contains both fermented liquid and particulate, suspended, colloidal and dissolved contaminants, including yeast, suspended solids and colloidal haze particles, etc., is filtered to render a clear liquid.

A method of performing filtration may include providing a filtration device as described above. In some embodiments, the fermentation broth produced during winemaking is introduced through a feed port of the filtration device. The rotor is rotating by actuating the rotational drive means so as to facilitate the formation of Taylor vortices and/or increase the sheer the fermentation broth is exposed to. Preferably, the Taylor number is about 639 and the shear rate is 7983/sec for wine. The liquid wine passes through the filter element of the device and is collected from the filtrate port(s). The contaminants exit through the concentrate port of the device.

Table 1 above presents a range of configurations and rotation speeds for a filtration device. The top row of Table 1 illustrates a configuration commonly used to separate plasma from whole human blood at a filtration rate of 50 mL/min. The gap and rpm were chosen to maximize filtration rate while minimizing damage to the human blood cells.

Practical applications in commercial filtration demand much larger feed rates. Table 1 shows how the size, gap and RPM can be adjusted and still offer the same Taylor number and shear rate previously optimized for blood separation. For example, the last row of Table 1 shows that a rotor of 42 cm, with a case length of 80 cm, a gap of 0.106 cm and rotated at 385 RPM provides a Taylor number (637) and shear rate (7983/sec) very close to the ones for a filtration device used for blood separation mentioned above. However, this geometry offers 174 times the surface area (10550 cm²/60.8 cm²). Since the filtration rate is approximately linearly related to the surface area of membrane, this geometry produces a filtration flow rate of about 8700 mL/min (50 mL/min×174) or 8.7 L/min or about 2 gallons/minute. Doubling the length from 80 cm to 160 cm doubles the filtration rate to about 4 gallons/min.

The operating parameters developed for blood are only offered as an example. Constraints there include the fact that the feed solution (whole blood) is approximately 40% cells (40% solids in a sense) and extremely shear sensitive. In many commercial applications, the percentage of solids in the feed solution is much less, and the sensitivity of the feed solution to shear is much lower. For example, the final clarification/filtration step before bottling wine could have a percentage of solids less than 1%, and the shear sensitivity may be totally absent, other than preventing significant frictional heat. In these cases, filtration flow rates are many times higher than derived in filtration of whole human blood.

What is claimed is:

1. A filtration device, comprising
a cylindrical housing, comprising a feed port, a filtrate port and a concentrate port;
a filter element disposed coaxially within the housing;
a cylindrical rotor disposed coaxially within the filter element; and
a filter support configured to support the filter element coaxially between the rotor and the housing;
wherein a gap is located between the rotor and the filter element.

2. The filtration device of claim 1, wherein the gap is sized to create Taylor vortices during operation.

3. The filtration device of claim 1, wherein the gap is sized to provide a Taylor number of about 100 to about 60000 during operation.

4. The filtration device of claim 1, wherein the gap is sized to provide a Taylor number of about 200 to about 10000 during operation.

5. The filtration device of claim 1, wherein the gap is sized to provide a Taylor number of about 400 to about 4000 during operation.

6. The filtration device of claim 1, wherein the gap is sized to provide a Taylor number of about 500 to about 3000 during operation.

7. The filtration device of claim 1, wherein the gap is sized to provide a Taylor number of about 600 to about 1000 during operation.

8. The filtration device of claim 1, wherein the gap is sized to provide a shear rate of about 1270 to about 152400 sec⁻¹ during operation.

9. The filtration device of claim 1, wherein the gap is sized to provide a shear rate of about 3810 to about 76200 sec⁻¹ during operation.

10. The filtration device of claim 1, wherein the gap is sized to provide a shear rate of about 5080 to about 38100 sec⁻¹ during operation.

11. The filtration device of claim 1, wherein the gap is sized to provide a shear rate of about 6350 to about 20320 sec⁻¹ during operation.

12. The filtration device of claim 1, wherein the gap is sized to provide a shear rate of about 7620 to about 12700 sec⁻¹ during operation.

13. The filtration device of claim 1, wherein the gap is sized to provide a ratio of Taylor number to shear rate of about 0.02 to about 15 sec during operation.

14. The filtration device of claim 1, wherein the gap is sized to provide a ratio of Taylor number to shear rate of about 0.04 to about 8 sec during operation.

15. The filtration device of claim 1, wherein the gap is sized to provide a ratio of Taylor number to shear rate of about 0.08 to about 1 sec during operation.

16. The filtration device of claim 1, wherein each filtration element defines a filtration area, and the sum of the filtration areas is between about 50 and 50000 cm².

17. The filtration device of claim 1, wherein each filtration element defines a filtration area, and the sum of the filtration areas is between about 100 and 25000 cm².

18. The filtration device of claim 1, wherein each filtration element defines a filtration area, and the sum of the filtration areas is between about 300 and 20000 cm².

19. The filtration device of claim 1, wherein each filtration element defines a filtration area, and the sum of the filtration areas is between about 800 and 12000 cm².

20. The filtration device of claim 1, wherein the filtration element support comprises a plurality of element support sections, wherein each section supports a substantially different portion of the filtration element.

21. The filtration device of claim 1, wherein each of the plurality of filtration element support sections can be separated from the filtration element.

22. A filtration method, comprising:
providing the filtration device of claim 1;
rotating the rotor by engaging a rotational drive means;
introducing a solution or suspension to be filtered into the feed port of the filtration device, wherein the solution or suspension comprises a clear liquid and contaminating matter;
collecting a clarified filtrate, substantially free of contaminating matter, from the at least one filtrate ports; and
collecting a concentrate comprising the contaminating matter from the concentrate port.

23. The method of claim 22, wherein the solution or suspension to be filtered is selected from the group consisting of fermentation broth (wört) for beer, fermentation broth for wine, cider, fermentation broth for a distilled spirit, unseparated (whole) fermentation broth, separated fermentation broth, an extract, a plant stream and a fruit juice.
